(19) United States
(12) Patent Application Publication
(10) Pub. No.: US 2010/0120004 A1
(43) Pub. Date: May 13, 2010

(54) SYMBOLTEC

(76) Inventor: Angele Hendrys, New Rochelle, NY (US)

Correspondence Address: Angele Hendrys, 541, Pelham Road, apt. 7P, New Rochelle, NY, 10805, US

(21) Appl. No.: 11/741,755

(22) Filed: Nov. 12, 2008

(51) Int. Cl. G09B 19/00

(52) U.S. Cl. 434/236

(57) ABSTRACT

Our subconscious is much smarter than our waking mind but our dreaming mind can be trained to learn a technique (Symboltec) that makes communication between the two accurate, fast and easy. A chart with symbols and a code is all that is needed to ask questions which the dreaming mind answers in its own universal language, that is pictures, which are easy to read. No interpretation is necessary, you just make a note of the picture and decode it.

Since our dreaming mind has the ability to make premonitory dreams, it can also make estimations and projections which are far more accurate than those made in our waking state when we are often misled by wishful thinking and ideologies.

Symboltec is a completely new technique—nothing similar exists—to solve problems and make accurate estimations.

### HOW IT WORKS

Unless you are an expert in a particular field, you first do the research and prepare your questions.

For each question—positive YES at left, negative NO at right, you chose a symbol and a color (see chart and code below).

You get your answers in dream imagery and your dreaming mind illustrates the answer or the solution of the problem usually in a single picture developed from the symbol and/or the color chosen for your question. The picture has to be decoded with the chart.

If you are not a psychologist, or have a good knowledge of dreams and psychology, this needs some training and it is planned that instructors, a manual and a CD will be available in a couple of years. Experiments in various fields are still in progress. See claims attached.

CHART

| Letters/ | | |
|---|---|---|
| Numbers | Colors | Shapes |
| A or 1 | Aqua | triangle |
| B 2 | Black | ball, button |
| C 3 | Yellow | circle, cup, curve |
| D 4 | Brown | square |
| E 5 | Red | envelope, red button |
| F 6 | Blue | fence, fish |
| G 7 | Orange | oval |
| H 8 | Purple | rectangle |
| I 9 | Green | star |
| J 10 | White | white band |
| K 11 | Khaki | key |
| L 12 | Pink | line etc . . . |

Note 1: you don't need colors and shapes for letters that you rarely use, like X or Z. It's enough to remember that X=24 and Z=26; Y=25 comes often as in Young, You, Yellow. You can choose a deep yellow to differentiate Y from C 3.

Note 2: you can chose any kind of shape, and the answers will also come in a variety of shapes for letters with many familiar words like C 3 ( curve, circle, cup, computer, counter) if there is one that better illustrates the answer.
In dream imagery one size does not fit all and your personal chart should fit your age, gender and occupation with the colors most likely to appear in your dreams.
This code of letters, numbers, colors, shapes which you will use as symbols to ask your questions is enough to cope with the infinite variety of the answers in dream imagery.

1. Hurricanes
Date: Jul. 9, 1996
QUESTION: Hurricane Berta heads:

| West | North | East |
|---|---|---|
| [symbol] | □ | [symbol] |
| Red | blue | green |

ANSWER IN DREAM IMAGERY; A narrow road in a green countryside.
The mostly green picture means EAST: Four days before the meteorologists the dreaming mind has made the accurate calculations.
Date Apr. 7, 2006
In an email to Scitimes@nytimes.com my projection for the 2006 hurricane season was: no hurricanes on the Gulf Coast and only one likely to hit the East Coast. This proved to be accurate with “Ernesto” crossing Florida without major damage. Article in the New York Times of Nov. 30, 2006: “Not one hurricane strikes the United States”.
The prediction made on the Weather Channel was: “Experts predict very active season”, 6 major hurricanes in 2006 season, later downgraded twice and still inaccurate.

2. Economy
Date: Aug. 23, 2001, Economic growth will rebound to 3.2 in 2002. Article published in the New York Times: Bush projections . . . ” Ma projection was sent to: letters@nytimes.com
QUESTION:

| True | False |
|---|---|
| [symbol] | [symbol] |
| Black | Red |

ANSWER IN DREAM IMAGERY: my red little staple—one of those tiny Swingline “Tot 50”—which obviously meant that the economic growth would be noticeably smaller. This was proven accurate in an AP news article on the Internet on Aug. 29, 2002: “After bolting out of the starting gate at the beginning of the year, the U.S. economy slowed in the spring, growing an annual rate of just 1.1%.”

3. Flu Pandemic
Date: Apr. 25, 2005
QUESTION: We are now in the 21st century, not in 1918, with means to contain an epidemic and isolate stricken areas. Therefore a flu pandemic would in no way be a disaster similar to the killer flu of 1918:

| True | False |
|---|---|
| [symbol] | [symbol] |
| Purple | Gray |

ANSWER IN DREAM IMAGERY: a girl with blond hair at left. H is the code for purple and it is at left.
This means that it is true that a flu pandemic when it happens, likely in the fall of 2007, will not be as deadly by far as the Spanish flu of 1918.
Note: A previous projection indicated that the pandemic would not be caused by the H5N1 virus which can't be transmitted human to human but by a new strain like the H5N1 Fujian-like which is not as deadly.
